(19) United States
(12) Patent Application Publication
(10) Pub. No.: US 2018/0056290 A1
(43) Pub. Date: Mar. 1, 2018

(54) SAMPLE COLLECTION CHIP

(71) Applicants: CAPITALBIO EHEALTH SCIENCE & TECHNOLOGY (BEIJING) CO., LTD., Beijing (CN); CHONGQING EHEALTH JIUYETANG BIOLOGICAL TECHNOLOGY CO., LTD., Chongqing (CN); TSINGHUA UNIVERSITY, Beijing (CN)

(72) Inventors: Youchun Xu, Beijing (CN); Haoying Shao, Beijing (CN); Cheng Chen, Beijing (CN); Liangbin Pan, Beijing (CN)

(21) Appl. No.: 15/686,025

(22) Filed: Aug. 24, 2017

(30) Foreign Application Priority Data
Aug. 30, 2016 (CN) 201610785032.6

(51) Int. Cl. B01L 3/00

(52) U.S. Cl. CPC B01L 3/502; B01L 2300/161; B01L 2300/0838; B01L 2300/0861; B01L 2400/0409

(57) ABSTRACT

A sample collection chip is disclosed in this application, which includes a chip body. The chip body is provided therein with a collection channel and a sample quantitation cell. The collection channel is in communication with the outside via a sample inlet located in a surface of the chip body, the collection channel has a sample-philic property; and the sample quantitation cell and the collection channel are in communication with each other via a first capillary channel, the first capillary channel has a flow section smaller than a flow section of the collection channel, the first capillary channel has a sample-phobic property, and the sample quantitation cell is in communication with an air outlet located in a surface of the chip body via a second capillary channel.

### CROSS-REFERENCE TO RELATED APPLICATIONS

This application claims the benefit of priority to Chinese Patent Application No. 201610785032.6 titled “SAMPLE COLLECTION CHIP” and filed with the Chinese State Intellectual Property Office on Aug. 30, 2016, the entire disclosure of which is incorporated herein by reference.

### FIELD

This application relates to the field of analysis and detection techniques, and particularly to a sample collection chip.

### BACKGROUND

Sample collection is the first step of various analysis and detection techniques and methods, and is an important prerequisite for achieving full-automatic analysis. Current analytical apparatuses, such as full-automatic biochemical analyzers and immunoassay analyzers, all employ a plunger pump to control a sampling needle to perform quantitative sampling of liquid samples. Though this method is accurate, it requires an expensive and complex apparatus and requires a complex positioning device. In addition, pipettes are also commonly used collecting and transferring devices for liquid samples. However, in the process of using a pipette or a plunger pump to control the sampling needle to draw an external sample and then fill it into a reaction device, it is required to perform operations of liquid drawing, transferring and outputting, and further an additional movement control device or manual operations are required, thus, the sampling operation is troublesome, the apparatus used has a high cost, and professionals are required to operate. In addition, in the above method, sample collection and reaction are separately performed in different containers or mediums, which does not facilitate integrated and portable operation.

In summary, it is urgent for the person skilled in the art to address the issues that the sampling operation is troublesome, sample collection devices are complex, expensive, and do not facilitate integrated and portable operation.

### SUMMARY

In view of this, an object of the present application is to provide a sample collection chip for simplifying sampling operation and structure, reducing cost, facilitating integrated and portable operation.

In order to achieve the above object, the following technical solutions are provided according to the present application.

A sample collection chip includes a chip body, and the chip body being provided therein with:

a collection channel, the collection channel is in communication with an outside via a sample inlet located in a surface of the chip body, and the collection channel has a sample-philic property; and

a sample quantitation cell, the sample quantitation cell and the collection channel are in communication with each other via a first capillary channel, the first capillary channel has a flow section smaller than a flow section of the collection channel, the first capillary channel has a sample-phobic property, and the sample quantitation cell is in communication with an air outlet located in the surface of the chip body via a second capillary channel.

Preferably, in the sample collection chip described above, the first capillary channel and the collection channel are in an arc-shaped convergent transition.

Preferably, in the sample collection chip described above, an end, in communication with the sample quantitation cell, of the first capillary channel is a flared end expanding gradually toward the sample quantitation cell.

Preferably, in the sample collection chip described above, an area of the flow section of the collection channel ranges from 0.04 mm² to 6 mm², inclusive, and an area of the flow section of the first capillary channel is 1/100 to ¼ times of the area of the flow section of the collection channel.

Preferably, in the sample collection chip described above, the surface of a portion, around the sample inlet, of the chip body has a sample-phobic property.

Preferably, in the sample collection chip described above, the chip body is a plate-like chip body, the plate-like chip body has a tapered corner, and the sample inlet is arranged in an outer peripheral end surface of the tapered corner.

Preferably, in the sample collection chip described above, the chip body includes a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

Preferably, in the sample collection chip described above, outer peripheral side surfaces of two sides of the tapered corner are respectively provided with two liquid retaining protrusions close to the sample inlet.

Preferably, in the sample collection chip described above, the chip includes a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet extends outwards beyond an outer peripheral edge of the structural layer.

Preferably, in the sample collection chip described above, an absorbent material for absorbing a residual sample is provided in the second cover sheet.

Compared with the conventional technology, the present application has the following beneficial effects.

The sample collection chip according to the present application includes a chip body. The chip body is provided therein with a collection channel, a sample quantitation cell, a first capillary channel and a second capillary channel. The collection channel is in communication with the outside via a sample inlet located in the surface of the chip body, the collection channel has a sample-philic property. The sample quantitation cell and the collection channel are in communication with each other via the first capillary channel. The first capillary channel has a flow section smaller than a flow section of the collection channel. The first capillary channel has a sample-phobic property. The sample quantitation cell is in communication with an air outlet located in the surface of the chip body via the second capillary channel. The collection channel is in communication with the outside via the sample inlet, and the collection channel has a sample-philic property. Therefore, the sample collection chip automatically draws the sample into the collection channel by a capillary action of the collection channel. While the first capillary channel has a sample-phobic property, and the first capillary channel has a flow section smaller than that of the collection channel, therefore, an interface valve is formed between the first capillary channel and the collection channel, and the sample cannot automatically enter the first capillary channel. By performing a centrifuging operation on the sample collection chip in a centrifugal direction from the collection channel to the sample quantitation cell, the sample in the collection channel can be driven by the centrifugal force into the sample quantitation cell, to accomplish the sampling of the sample. Therefore, the sample collection chip can utilize the capillary action to automatically draw the sample, the operation is simple, the structure is simple without using high cost devices such as a plunger pump, the cost is reduced, and the collected sample is stored in the sample collection chip, and can be directly used for detection and analysis of an analysis equipment, thereby facilitating integrated and portable operation.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a schematic exploded view showing the structure of a sample collection chip according to an embodiment of the present application;

FIG. 2 is a schematic perspective view showing the structure of the sample collection chip in FIG. 1 in an assembled state;

FIG. 3 is a top view of a structural layer of the sample collection chip in FIG. 1;

FIG. 4 is a schematic view showing the structure of the structural layer of the sample collection chip in FIG. 1;

FIG. 5 is a schematic sectional view taken along line A-A in FIG. 4.

FIG. 6 is a partially enlarged view of a first capillary channel of a sample collection chip according to an embodiment of the present application;

FIG. 7 is a top view of a structural layer of a second type of the sample collection chip according to an embodiment of the present application;

FIG. 8 is a schematic view showing the structure of the structural layer in FIG. 7;

FIG. 9 is a schematic view showing the structure of a structural layer of a third type of the sample collection chip according to an embodiment of the present application;

FIG. 10 is a schematic exploded view of a fourth type of the sample collection chip according to an embodiment of the present application;

FIG. 11 is a schematic perspective view showing the assembled structure of the sample collection chip in FIG. 10; and

FIG. 12 is a top perspective view of the sample collection chip in FIG. 11.

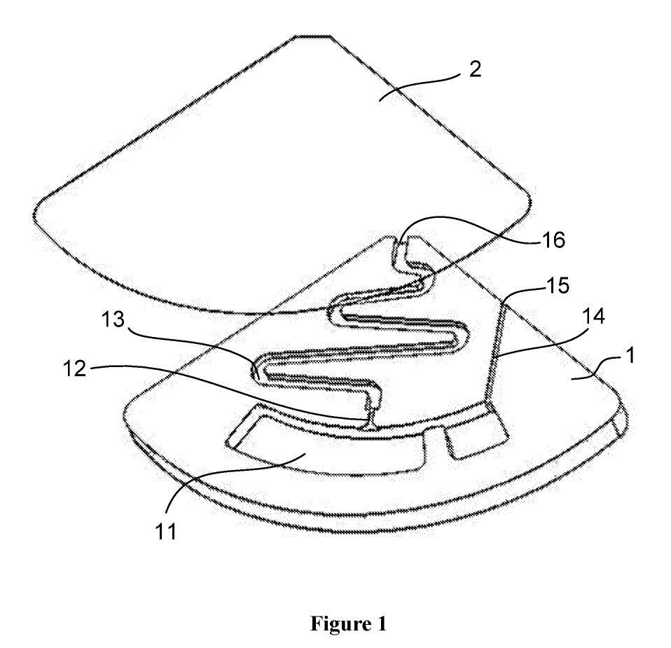

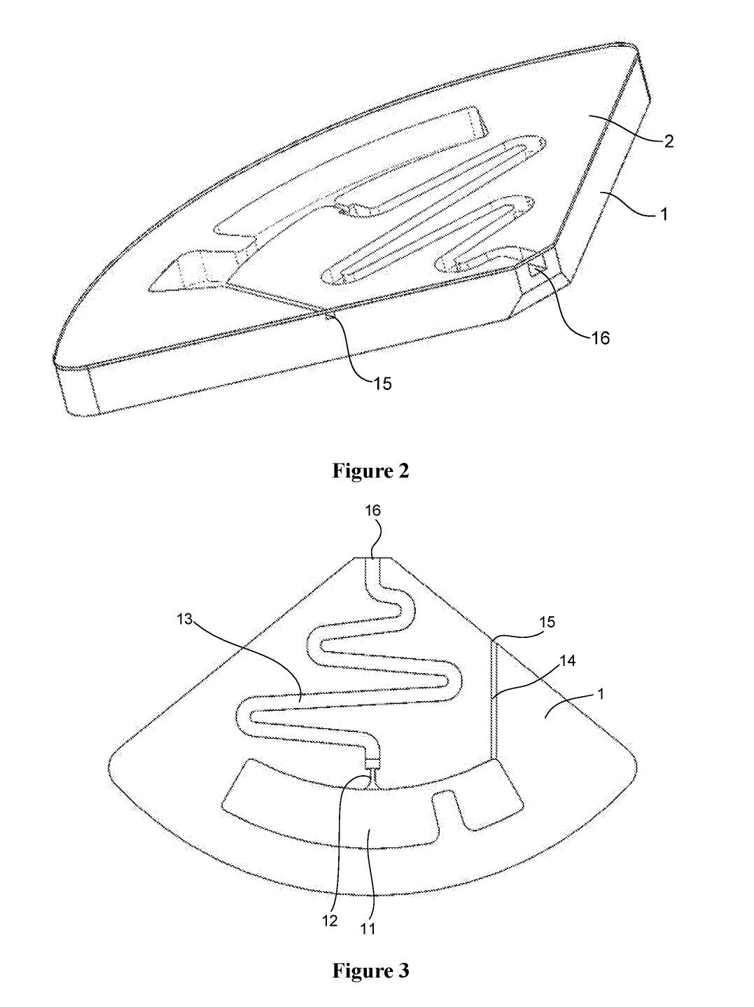

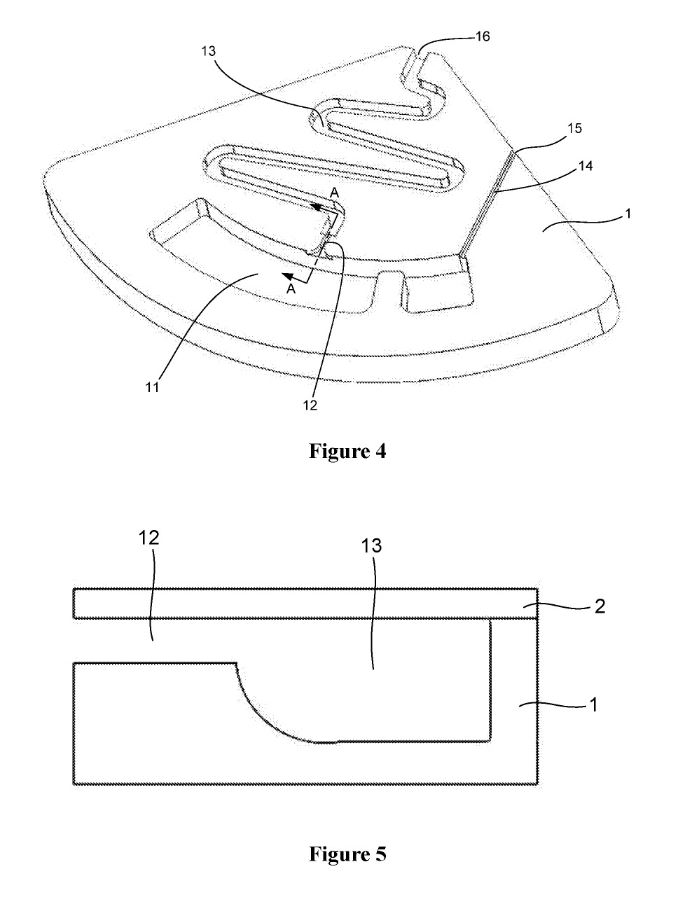

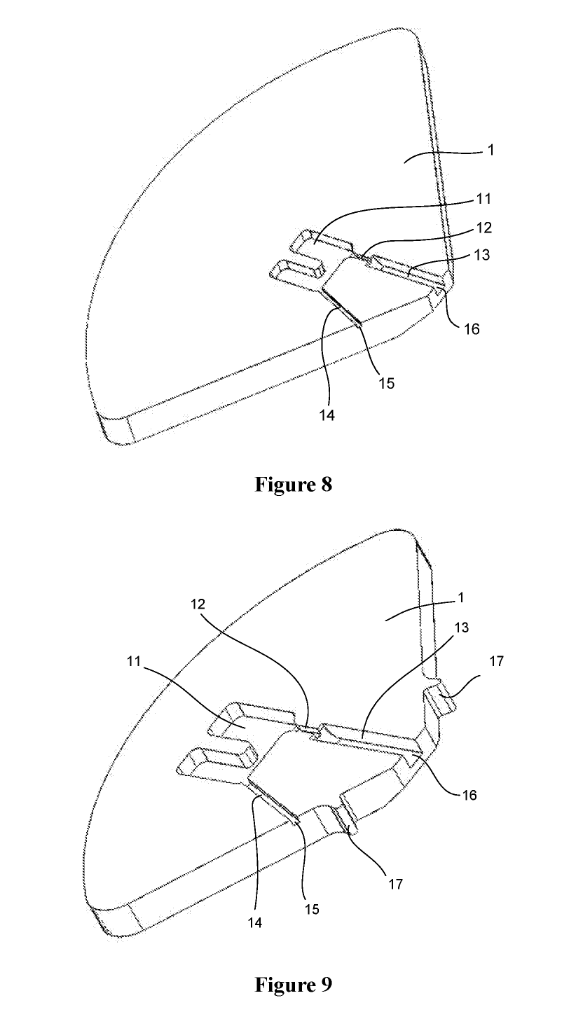

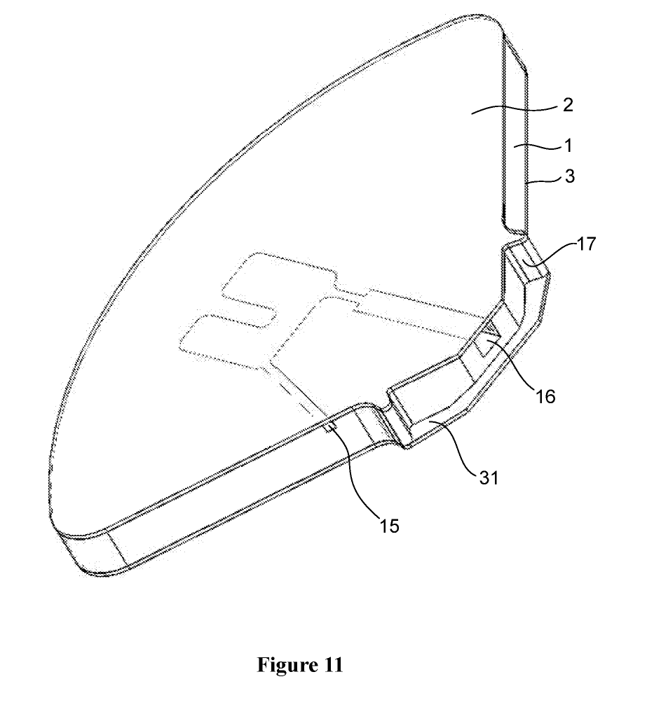

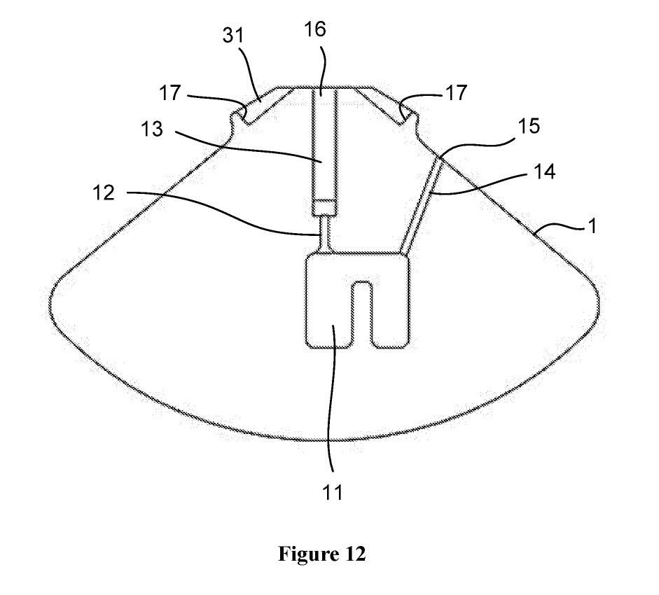

Reference Numerals in FIGS. 1 to 12:

| | | | |
|---|---|---|---|
| 1 | structural layer, | 11 | sample quantitation cell, |
| 12 | first capillary channel, | 13 | collection channel, |
| 14 | second capillary channel, | 15 | air outlet, |
| 16 | sample inlet, | 17 | liquid retaining protrusion, |
| 2 | first cover sheet, | 3 | second cover sheet, |
| 31 | retaining edge. | | |

### DETAILED DESCRIPTION

A sample collection chip is provided according to the present application, which simplifies sampling operation and structure, reduces cost, and facilitates integrated and portable operation.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

Referring to FIGS. 1 to 12, a sample collection chip is provided according to an embodiment of the present application, which includes a chip body. A collection channel 13, a sample quantitation cell 11, a first capillary channel 12 and a second capillary channel 14 are provided in the chip body. The collection channel 13 is in communication with the outside via a sample inlet 16 located in a surface of the chip body, the collection channel 13 has a sample-philic property. The sample quantitation cell 11 and the collection channel 13 are in communication with each other via the first capillary channel 12. The first capillary channel 12 has a flow section smaller than a flow section of the collection channel 13, which allows an interface valve to be formed between the collection channel 13 and the first capillary channel 12. The first capillary channel 12 has a sample-phobic property. The sample quantitation cell 11 is in communication with an air outlet 15 located in the surface of the chip body via the second capillary channel 14, to maintain the atmospheric pressure in the sample quantitation cell 11.

The working principle and working process of the above sample collection chip are described as follows. The collection channel 13 is in communication with the outside via a sample inlet 16, and the collection channel 13 has a sample-philic property. Therefore, when the sample inlet 16 of the sample collection chip comes into contact with a sample, the sample collection chip automatically draws the sample into the collection channel 13 by the syphonage of the collection channel 13. While, the first capillary channel 12 has a sample-phobic property and has a flow section smaller than that of the collection channel 13, therefore, the interface valve is formed between the first capillary channel 12 and the collection channel 13, the sample cannot automatically enter the first capillary channel 12. By performing a centrifuging operation on the sample collection chip in a centrifugal direction from the collection channel 13 to the sample quantitation cell 11, the sample in the collection channel 13 can be driven by the centrifugal force into the sample quantitation cell 11, to accomplish the quantitative sampling of the sample. Therefore, the sample collection chip can utilize syphonage to automatically draw the sample, the operation is simple, non-professionals can operate on their own as well, the structure is simple without using high cost devices such as a plunger pump, the cost is reduced, and the collected sample is stored in the sample collection chip as one module, and can be directly used for detection and analysis of an analysis equipment, thereby facilitating integrated and portable operation.

The sample collection chip of the present application can be used for biological detection, water contaminant detection, pesticide residue detection and other various fields, for example, realizing sampling and detection of whole blood, serum, plasma, urine, sweat, saliva, semen, amniotic fluid and other body fluids, or water samples, milk, fruit juice, heavy metal ion contaminants, organic contaminants, inorganic contaminants, pesticide residues and the like.

The sample-philic property of the collection channel 13 is optimized, which is illustrated by taking a water sample as an example. If the whole chip body is made of a hydrophobic material, such as polymethylmethacrylate, polycarbonate, polypropylene and other high-molecular polymers, the collection channel 13 needs to be subjected to a hydrophilic treatment or a local hydrophilic treatment such as spraying a hydrophilic coating in the collection channel 13 or applying a hydrophilic film in the collection channel 13, and the hydrophilic material may be metal, glass or the like. If the chip body is made of a hydrophilic material, such as metal, glass, then other structures and parts of the chip body other than the collection channel 13 need to be subjected to a hydrophobic treatment such as spraying a hydrophobic coating or applying a hydrophobic film, as long as it can ensure that the collection channel 13 has a hydrophilic property. For other samples, according to different properties of the sample, appropriate materials are selected to achieve the sample-philic property and the sample-phobic property.

As shown in FIG. 5, in this embodiment, the first capillary channel 12 and the collection channel 13 are in an arc-shaped convergent transition, that is, the collection channel 13 is transited to the first capillary channel 12 through an arc, to avoid a right-angled transition. The arc-shaped convergent transition can prevent liquid from remaining in the tail end of the collection channel 13 when the liquid is driven by an external centrifugal force to enter the sample quantitation cell 11 via the first capillary channel 12 from the collection channel 13.

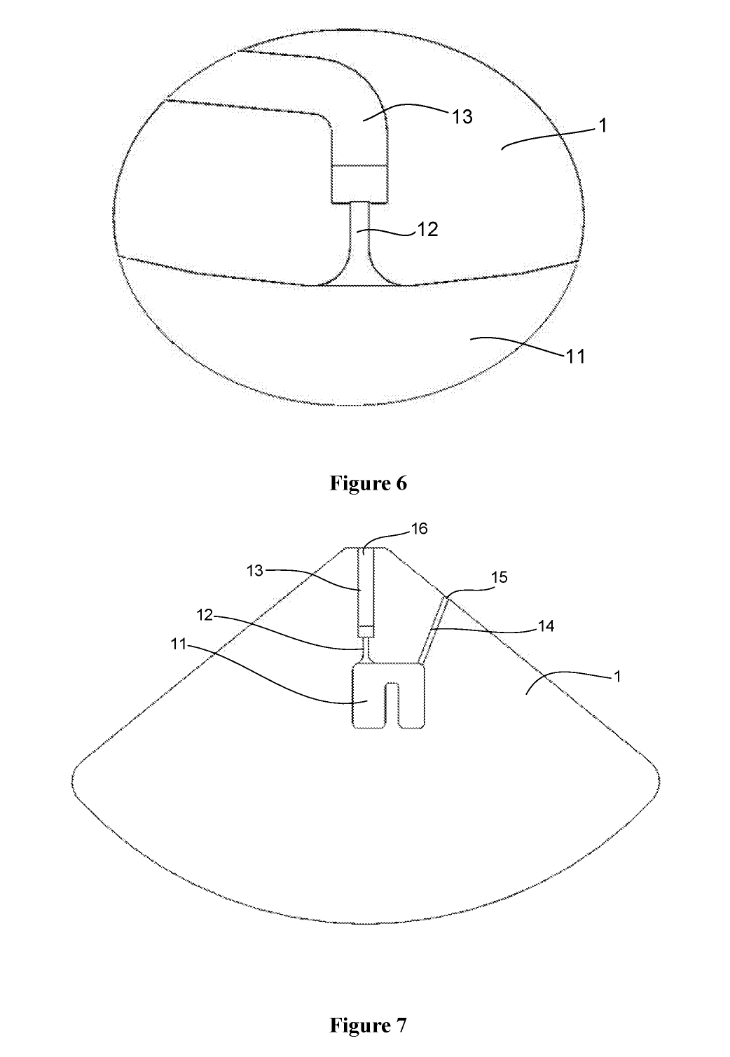

As shown in FIG. 6, further, in this embodiment, an end, in communication with the sample quantitation cell 11, of the first capillary channel 12 is a flared end which expands gradually toward the sample quantitation cell 11. That is, an end, connected to the collection channel 13, of the first capillary channel 12 is thin, and the end, connected to the sample quantitation cell 11, of the first capillary channel 12 is gradually widened toward the sample quantitation cell 11 and has a bell mouth shape. The first capillary channel 12 employing this structure has the following effects. The thin portion of the first capillary channel 12 facing the collection channel 13 facilitates the formation of an “interface valve” through interface mutation to prevent the sample from being siphoned into the first capillary channel 12 from the sample quantitation cell 11. Moreover, the flared end, in connection with the sample quantitation cell 11, of the first capillary channel 12 is to minimize the effect of the “interface valve” caused by the interface mutation and to prevent liquid from being remained in the first capillary channel 12 in the centrifugal operation.

In this embodiment, the area of the flow section of the collection channel 13 ranges from 0.04 mm² to 6 mm², inclusive, and the area of the flow section of the first capillary channel 12 ranges from 1/100 to ¼ times of that of the collection channel 13. The flow section of the collection channel 13 may be in the shape of a circle, a rectangle, a semicircle, or the like. For convenience of processing, the flow section of the collection channel 13 is embodied as a rectangular shape. Preferably, the flow section of the collection channel 13 has a width ranging from 0.2 mm to 3 mm, inclusive, and a depth ranging from 0.2 mm to 2 mm, inclusive, and the width and depth of the first capillary channel 12 are 1/10 to ½ of the width and depth of the collection channel 13. The above sizes are not limited as long as the effect of an interface valve can be achieved between the first capillary channel 12 and the collection channel 13. The length and flow section area of the collection channel 13 are determinants of the maximum collection amount of the collected sample. Therefore, the collection channel 13 having an appropriate length and flow section can be selected according to the amount of a sample required for the sample detection, and as shown in FIGS. 3 and 7, different sample collection chips may be provided with collection channels 13 of different lengths and shapes, and the size of the sample collection chip may be changed accordingly, which is not limited here. When collecting a micro-sample, such as blood, especially fingertip blood, the sample volume preferably ranges from 2 microliters to 20 microliters.

In this embodiment, the surface of a portion, around the sample inlet 16, of the chip body has a sample-phobic property, and this configuration is to avoid contamination of the sample collection chip resulted from sample residual around the sample inlet 16.

Further, in this embodiment, the chip body is a plate-like chip body, the sample inlet 16 and the air outlet 15 are arranged in an outer peripheral side surface of the plate-like chip body, to avoid potential contamination caused by the hand touching the sample inlet 16 and the air outlet 15 when holding an upper side and a lower side of the plate-like chip body. More preferably, the plate-like chip body has a tapered corner, and the sample inlet 16 is arranged in an outer peripheral end surface of the tapered corner. When sampling, the sample inlet 16 in the end surface of the tapered corner is allowed to come into contact with the sample to collect the sample, and since the sample inlet 16 is arranged in the outer peripheral end surface of the tapered corner, the contact area of the sample collection chip in contact with the solution sample is reduced, thereby avoiding sample residual on the outer surface of the sample collection chip as far as possible.

The shape of the plate-like chip body may be a fan shape, a rhombic shape, a rectangular shape, a triangular shape or an elliptical shape or any other shape which has a tapered corner. FIGS. 1 to 4 and 7 to 12 show a chip body of a fan-shaped structure, and the tapered corner is just a sharp corner of the fan shape, and the sample inlet 16 is arranged at the sharp corner. For the plate-like chip body of other shapes, the arrangement position of the sample inlet 16 is similar to that of the plate-like chip body of the fan-shaped structure.

As shown in FIGS. 1 to 5, a specific chip body is provided according to this embodiment, the chip body includes a structural layer 1 and a first cover sheet 2, and the first cover sheet 2 is covered on the structural layer 1 in a sealed manner. The collection channel 13, the sample quantitation cell 11, the first capillary channel 12 and the second capillary channel 14 are formed by sealing the structural layer 1 and the first cover sheet 2. The sample inlet 16 is arranged in an outer peripheral side surface of the structural layer 1, and the air outlet 15 may also be arranged in an outer peripheral side surface of the structural layer 1. The structural layer 1 and the first cover sheet 2 have matching shapes, which may be a fan shape, a rhombic shape, a rectangular shape, a triangular shape, an elliptical shape or a circular shape, and the like. The material of the structural layer 1 and the first cover sheet 2 may be high-molecular polymers such as polymethylmethacrylate, polycarbonate or polypropylene, or may be glass or a metal material, or any combination of the above listed materials. A sample-philic treatment is performed at a location requiring a sample-philic property, and a sample-phobic treatment is performed at a location requiring a sample-phobic property. The structural layer 1 and the first cover sheet 2 are fixed to each other in a sealed manner by thermocompression bonding, laser welding, ultrasonic welding, or adhesive bonding.

The first cover sheet 2 may be a smooth flat panel, the collection channel 13, the sample quantitation cell 11, the first capillary channel 12 and the second capillary channel 14 are only arranged in the structural layer 1, and the first cover sheet 2 is covered on the structural layer 1 to allow the collection channel 13, the sample quantitation cell 11, the first capillary channel 12 and the second capillary channel 14 to be sealed and integrated. Or, the collection channel 13, the sample quantitation cell 11, the first capillary channel 12 and the second capillary channel 14 are partially arranged in the first cover sheet 2 and partially arranged in the structural layer 1, and the first cover sheet 2 and the structural layer 1 are combined together to allow the collection channel 13, the sample quantitation cell 11, the first capillary channel 12, and the second capillary channel 14 to be integrated. Or, the collection channel 13, the sample quantitation cell 11, the first capillary channel 12 and the second capillary channel 14 are arranged only in the first cover sheet 2, and the first cover sheet 2 and the structural layer 1 are combined to allow the integral collection channel 13, the sample quantitation cell 11, the first capillary channel 12 and the second capillary channel 14 to be integrated. Or, the collection channel 13 and the sample quantitation cell 11 are arranged in the structural layer 1, and the first capillary channel 12 and the second capillary channel 14 are arranged in the first cover sheet 2, and the first cover sheet 2 and the structural layer 1 are combined to allow the integral collection channel 13, the sample quantitation cell 11, the first capillary channel 12 and the second capillary channel 14 to be integrated.

The chip body is embodied in a layered structural form in which the first cover sheet 2 and the structural layer 1 are combined, which may facilitate the manufacturing of the internal structure of the chip body. Of course, the chip body may also be embodied as an integral structural form, and the internal structural may be formed by injection molding, 3D printing and other technologies.

As shown in FIG. 9, on the basis of the above sample collection chip, outer peripheral side surfaces of two sides of the tapered corner of the sample collection chip in this embodiment are respectively provided with two liquid retaining protrusions 17 close to the sample inlet 16. The two liquid retaining protrusions 17 are located at two sides of the liquid inlet port 16, and recessed structures are formed between the two liquid retaining protrusions 17 and the outer peripheral side surfaces of the tapered corner respectively. When the sample collection chip is centrifuged to collect liquid samples, the excess sample at the sample inlet 16 may be thrown out along the two sides of the sample inlet 16, and the thrown sample may contaminate the environment or an associated equipment, and if the sample is corrosive or has a biosafety issue, or the like, it may cause harm to the operator. In order to avoid potential contaminations of the sample, the sample collection chip in this embodiment is additionally provided with the two liquid retaining protrusions 17 at two sides of the sample inlet 16. Thus, when performing the centrifugal operation, the excess sample at the sample inlet 16 is retained in the recessed structures by the two liquid retaining protrusions 17, thereby preventing the excess sample from being thrown out and protecting the centrifugal device and the operator.

In the case that the chip body is composed of the first cover sheet 2 and the structural layer 1, the liquid retaining protrusions 17 are provided on both the structural layer 1 and the first cover sheet 2. In the case that the chip body is an integral structure, the liquid retaining protrusions 17 are arranged on the outer peripheral side surface of the chip body.

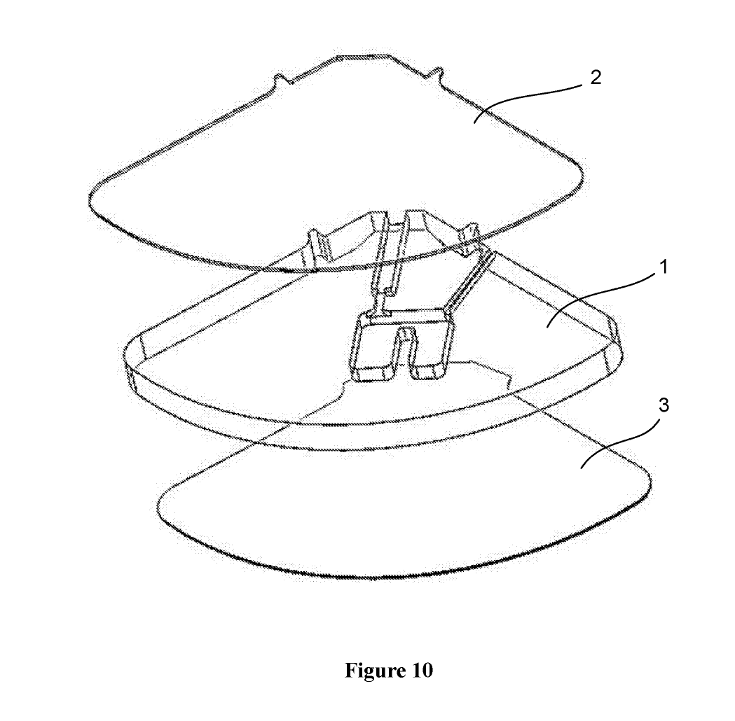

As shown in FIGS. 10 to 12, another sample collection chip is provided according to this embodiment, and a chip body of this sample collection chip includes a second cover sheet 3 in addition to the structural layer 1 and the first cover sheet 2 mentioned in the above embodiments, and the first cover sheet 2 is covered on the structural layer 1 in a sealed manner. The collection channel 13, the sample quantitation cell 11, the first capillary channel 12 and the second capillary channel 14 are formed by sealing the structural layer 1 and the first cover sheet 2. The second cover sheet 3 is arranged on a side, away from the first cover sheet 2, of the structural layer 1. The structural layer 1 has a tapered corner, and the sample inlet 16 is provided in an outer peripheral end surface of the tapered corner. Outer peripheral side surfaces of two sides of the tapered corner are respectively provided with two liquid retaining protrusions 17 close to the sample inlet 16. An outer peripheral edge, corresponding to a portion between the two liquid retaining protrusions 17, of the second cover sheet 3 is provided with a retaining edge 31 extending outwards beyond an outer peripheral edge of the structural layer 1, that is, the first cover sheet 2 and the second cover sheet 3 are respectively provided on an upper side and a lower side of the structural layer 1, and the area, corresponding to the portion between the liquid retaining protrusions 17, of the second cover sheet 3 is greater than the area of the corresponding portion of the structural layer 1. The retaining edge 31, the two liquid retaining protrusions 17 and the tapered corner define a dustpan-shaped structure, and the sample inlet 16 is located in the dustpan-shaped structure. Therefore, when centrifugal operation is performed, the excess sample at the sample inlet 16 is thrown into the dustpan-shaped structure, thereby further preventing the excess sample from being thrown out and realizing better protection for the centrifugal apparatus and the operator.

Further, the material of the second cover sheet 3 is similar to that of the first cover sheet 2 and is bonded to the structural layer 1 by thermocompression bonding, laser welding, ultrasonic welding, adhesive bonding or other techniques. In particular, an adsorbent material for adsorbing residual samples is arranged in the second cover sheet 3, and a water sample is taken as an example for illustration, the absorbent material is absorbent paper, cotton or sponge, and is preferably arranged at the dustpan-shaped structure to adsorb the excess sample, thereby better preventing the sample from being thrown out and protecting the centrifugal apparatus and the operator.

In this embodiment, the first capillary channel 12, the second capillary channel 14, and the air outlet 15 may be partially or entirely provided in the first cover sheet 2 or the second cover sheet 3.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A sample collection chip, comprising a chip body, and the chip body being provided therein with:
a collection channel, wherein the collection channel is in communication with an outside via a sample inlet located in a surface of the chip body, and the collection channel has a sample-philic property; and
a sample quantitation cell, wherein the sample quantitation cell and the collection channel are in communication with each other via a first capillary channel, the first capillary channel has a flow section smaller than a flow section of the collection channel, the first capillary channel has a sample-phobic property, and the sample quantitation cell is in communication with an air outlet located in the surface of the chip body via a second capillary channel.

2. The sample collection chip according to claim 1, wherein the first capillary channel and the collection channel are in an arc-shaped convergent transition.

3. The sample collection chip according to claim 1, wherein an end, in communication with the sample quantitation cell, of the first capillary channel is a flared end expanding gradually toward the sample quantitation cell.

4. The sample collection chip according to claim 1, wherein an area of the flow section of the collection channel ranges from 0.04 mm² to 6 mm², inclusive, and an area of the flow section of the first capillary channel is 1/100 to ¼ times of the area of the flow section of the collection channel.

5. The sample collection chip according to claim 1, wherein the surface of a portion, around the sample inlet, of the chip body has a sample-phobic property.

6. The sample collection chip according to claim 1, wherein the chip body is a plate-like chip body, the plate-like chip body has a tapered corner, and the sample inlet is arranged in an outer peripheral end surface of the tapered corner.

7. The sample collection chip according to claim 1, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

8. The sample collection chip according to claim 6, wherein outer peripheral side surfaces of two sides of the tapered corner are respectively provided with two liquid retaining protrusions close to the sample inlet.

9. The sample collection chip according to claim 1, wherein the chip body comprises a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet is provided with a retaining edge extending outwards beyond an outer peripheral edge of the structural layer.

10. The sample collection chip according to claim 9, wherein an absorbent material for absorbing a residual sample is provided in the second cover sheet.

11. The sample collection chip according to claim 2, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

12. The sample collection chip according to claim 2, wherein the chip body comprises a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet is provided with a retaining edge extending outwards beyond an outer peripheral edge of the structural layer.

13. The sample collection chip according to claim 3, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

14. The sample collection chip according to claim 3, wherein the chip body comprises a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet is provided with a retaining edge extending outwards beyond an outer peripheral edge of the structural layer.

15. The sample collection chip according to claim 4, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

16. The sample collection chip according to claim 4, wherein the chip body comprises a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet is provided with a retaining edge extending outwards beyond an outer peripheral edge of the structural layer.

17. The sample collection chip according to claim 5, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.

18. The sample collection chip according to claim 5, wherein the chip body comprises a structural layer, a first cover sheet and a second cover sheet, the first cover sheet is covered on the structural layer in a sealed manner, and the collection channel, the sample quantitation cell, the first capillary channel and the second capillary channel are formed by sealing the structural layer and the first cover sheet; the second cover sheet is arranged on a side, away from the first cover sheet, of the structural layer; the structural layer has a tapered corner, and the sample inlet is provided in an outer peripheral end surface of the tapered corner, and outer peripheral side surfaces of two sides of the tapered corner are respectively provided with two liquid retaining protrusions close to the sample inlet; an outer peripheral edge, corresponding to a portion between the two liquid retaining protrusions, of the second cover sheet is provided with a retaining edge extending outwards beyond an outer peripheral edge of the structural layer.

19. The sample collection chip according to claim 6, wherein the chip body comprises a structural layer and a first cover sheet covered on the structural layer in a sealed manner, and the collection channel, the sample quantitation cell, the first capillary channel and the second capillary channel are formed by sealing the structural layer and the first cover sheet, and the sample inlet is arranged in an outer peripheral side surface of the structural layer.
